(19) United States
(12) Patent Application Publication
(10) Pub. No.: US 2025/0357750 A1
(43) Pub. Date: Nov. 20, 2025

(54) CONTACTOR SELECTION TO OPEN UNDER LOAD

(71) Applicant: Caterpillar Inc., Peoria, IL (US)

(72) Inventors: Rodney L. Menold, Hanna City, IL (US); Bradley Scott Bailey, Edwards, IL (US)

(73) Assignee: Caterpillar Inc., Peoria, IL (US)

(21) Appl. No.: 18/668,851

(22) Filed: May 20, 2024

(51) Int. Cl. H02H 7/08; B60L 5/16; B60M 1/30

(52) U.S. Cl. CPC H02H 7/0827; B60L 5/16; B60M 1/30; B60L 2200/40

(57) ABSTRACT

A connection system for connecting a work machine to an external large-capacity energy source includes an electrically conductive member configured to provide electrical energy from the external energy source to an energy receptacle of the work machine; a first contactor mechanically movable between a closed position electrically connecting the external energy source and the electrically conductive member, and an open position physically disconnecting the external energy source and the electrically conductive member; a second contactor mechanically movable between a closed position electrically connecting the electrically conductive member and the energy receptacle, and an open position physically disconnecting the electrically conductive member and the energy receptacle; and controller configured to receive an indication to disconnect the electrical power system of the work machine from the external energy source; and selectively initiate opening of the first contactor or the second contactor according to the received indication.

### TECHNICAL FIELD

This document relates to electric powered work machines and in particular to techniques of safely connecting to the energy source of the work machines.

### BACKGROUND

Powering a large moving work machine (e.g., an electric mining truck) with an electric motor requires an electric energy source that can provide current of hundreds to thousands of Amperes (A) at hundreds to thousands of volts (V). The large-capacity energy source can be external to the work machine. For example, the work machine may include electrical contacts to a large-capacity external source that provides the electrical energy used to operate the machine. It may not always be possible to shut off the large-capacity external energy source when it is desired to remove power from the electric work machine. Therefore, electric work machines need a safe reliable technique to disconnect the external large-capacity energy source. U.S. Pat. No. 8,874,294 relates to a trolley assist-capable electric drive truck having a Direct Current (DC) link with first, second and third contactors that may be opened and closed in different configurations to operate the truck in different modes.

### SUMMARY OF THE INVENTION

Electric powered large moving work machines use a large-capacity energy source that sources high voltage electrical energy to the work machine. It may not always be possible to turn off the large-capacity energy source when the work machine needs to be disconnected from the large-capacity energy source. Equipment can be damaged if the large capacity energy source is not disconnected safely. Also, a sudden disconnect to a large-capacity energy may pose a threat of injury to workers from arcing due to a sudden open circuit with large currents and voltage.

An example connection system for connecting a work machine to an external large-capacity energy source includes an electrically conductive member configured to provide electrical energy from the external energy source to an energy receptacle of the work machine; a first contactor mechanically movable between a closed position electrically connecting the external energy source and the electrically conductive member, and an open position physically disconnecting the external energy source and the electrically conductive member; a second contactor mechanically movable between a closed position electrically connecting the electrically conductive member and the energy receptacle, and an open position physically disconnecting the electrically conductive member and the energy receptacle; and controller configured to receive an indication to disconnect the electrical power system of the work machine from the external energy source; and selectively initiate opening of the first contactor or the second contactor according to the received indication.

An example of a method of controlling operation of an electrically powered work machine includes receiving, by a controller of the work machine, an indication to disconnect an electrical power system of the work machine from an external energy source external to the work machine; and selectively initiating, by the controller, opening of one of a first movable contactor to mechanically disconnect an electrically conductive member from the external energy source or a second movable contactor to mechanically disconnect the electrically conductive member from an energy receptacle of the work machine in response to the indication to disconnect the electrical power system and according to an operating state of the work machine.

### BRIEF DESCRIPTION OF THE DRAWINGS

FIG. 1 is an illustration of an example work machine in accordance with this disclosure.

FIG. 2 is an illustration of an example of a work machine and an external electrical energy source in accordance with this disclosure.

FIGS. 3-5 are illustrations of additional examples of a work machine in accordance with this disclosure.

FIG. 6 is an exploded view of an enclosure for a contactor of a work machine in accordance with this disclosure.

FIG. 7 is a block diagram of portions of a connection system to connect a work machine and an external electrical energy source in accordance with this disclosure.

FIG. 8 is a flow diagram of an example of controlling operation of a work machine in accordance with this disclosure.

### DETAILED DESCRIPTION

Examples according to this disclosure are directed to methods and devices for managing high voltage electrical energy provided to electrical circuits and electrical motors of a work machine. Techniques for disconnecting a mobile work machine from an external large capacity energy source are described.

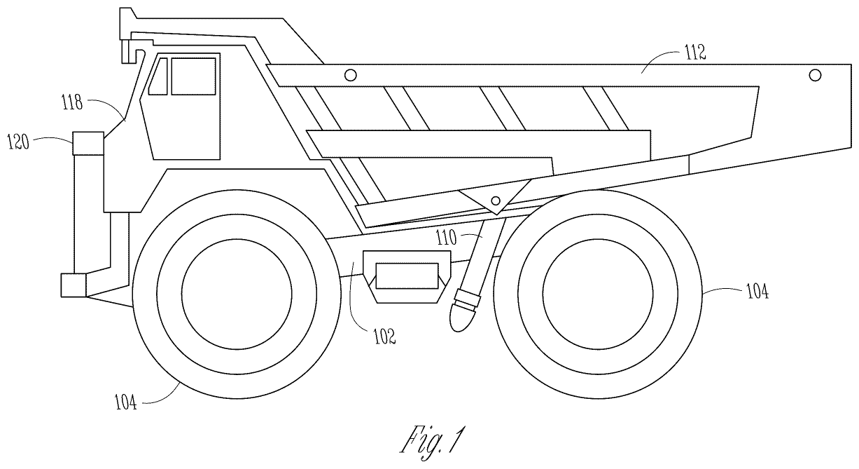

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a material hauler that is a large mining truck. In other examples, however, the machine may be other types of machines related to various industries, including, as examples, construction, agriculture, forestry, transportation, material handling, waste management, marine, stationary power, and so on. Accordingly, although some examples are described with reference to a material hauler machine, examples according to this disclosure are also applicable to other types of machines.

Machine 100 includes frame 102 mounted on four wheels 104, although, in other examples, the machine could have more than four wheels. Frame 102 is configured to support and/or mount one or more components of machine 100. For example, machine 100 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112. Bucket 112 may be configured to transfer material such as, soil, ore, or debris, from one location to another. Linkage assembly 110 can include one or more cylinders configured to be actuated hydraulically or pneumatically, for example, to articulate bucket 112. For example, linkage assembly 110 can be actuated by cylinders to raise and lower bucket 112 relative to frame 102 of machine 100.

Machine 100 also includes an operator cabin 118, which can be open or enclosed and may be accessed. Operator cabin 118 may include one or more control devices (not shown) such as, a joystick, a steering wheel, pedals, levers, buttons, switches, among other examples. The control devices are configured to enable the operator to control machine 100 and/or the bucket 112. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112. By further way of example, both operation by a remotely located operator and autonomous or robotic operation are contemplated.

Machine 100 can include an energy receptacle 120 to receive electrical energy from a large capacity external energy source. The machine 100 may receive high voltage, high direct current (DC) electrical energy (e.g., 700V-3000V and 300 A-1000⁺ A). The output of the battery system may be provided to a converter or inverter to produce high voltage, high alternating current (AC) electrical energy. The electrical energy is provided to electrical motors, pumps, circuits, etc., of the machine 100.

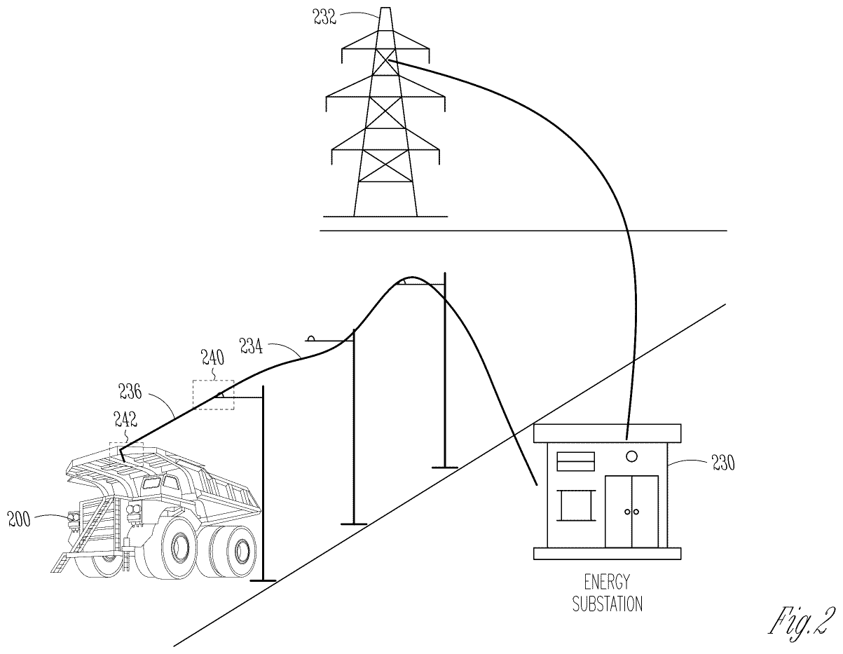

FIG. 2 is an illustration of an example of a work machine 200 that is a large mining truck (LMT) and an external electrical energy source. The work machine 200 may be any type of work machine. The external energy source includes an energy substation 230 that may be connected to a grid 232 (e.g., a job site grid or utility grid). The external electrical energy source includes an energy distribution system 234 that may include one or more power lines or cables to get electrical energy from the energy substation 230 to the machine 200. The machine 200 receives electrical energy from an electrically conductive member 236 connected to the energy distribution system, and the electrically conductive member 236 provides the electrical energy to the energy receptacle 120 of the machine 200. In the example of FIG. 2, the electrically conductive member 236 may be an electrically conductive tether or cable. The electrically conductive tether or cable may be straight as shown in FIG. 2 or catenary.

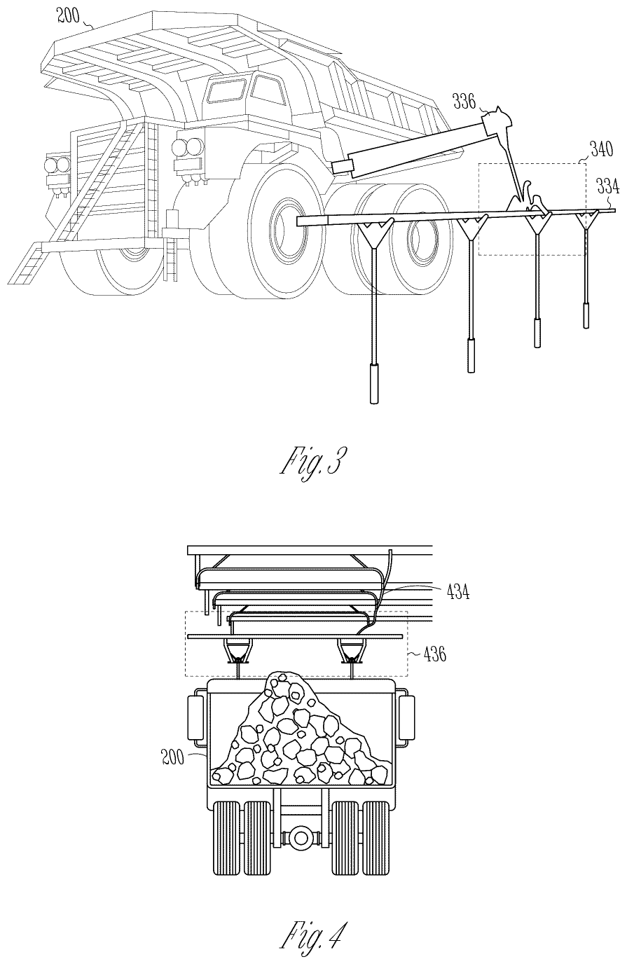

FIG. 3 is an illustration of another example of a work machine 200. The external energy source includes a power rail 334. Power rail 334 may distribute electrical energy from an energy substation 230. An electrically conductive member 336 carries electrical energy between the power rail 334 and the energy receptacle of the machine 200. The electrically conductive member 336 may include an electrically conductive tether or cable and one or more rigid arms to support the electrically conductive tether or cable.

FIG. 4 is an illustration of another example of a work machine 200. The external energy source includes one or more energy conducting lines 434. Energy conducting lines 434 may distribute electrical energy from an energy substation 230. An electrically conductive member 436 carries electrical energy between the energy conducting lines 434 and the energy receptacle of the machine 200. The electrically conductive member 436 includes an electrically conductive pantograph that contacts the energy conducting lines 434.

It may be desirable to physically disconnect the work machine from the external energy source. The connection system that connects the electrically conductive member to the external energy source includes a member contactor. The member contactor is mechanically moveable between a closed position and an open position. In the closed position, the electrically conductive member and the external energy source are physically and electrically connected. In the open position, the electrically conductive member and the external energy source are physically and electrically disconnected.

In the example of FIG. 2, the member contactor 240 is located at the end of the electrically conductive member 236 and physically connects and disconnects the electrically conductive member 236 and the energy distribution system 234. In the example of FIG. 3, the member contactor 340 is located at the end of the electrically conductive member 336 and includes a linkage to physically connect and disconnect the electrically conductive member 336 and the power rail 334. In the example of FIG. 4, the member contactor includes a linkage to physically connect and disconnect the electrically conductive pantograph and the energy conducting lines 434.

Under certain conditions it may be desired to suddenly disconnect the work machine 200 from the external energy source while the machine 200 is under load and the external energy source is transferring electrical energy to the work machine. Opening the member contactor under load can result in arcing at the point of disconnect, which may damage components of the member contactor, the electrically conductive member, and the external energy source, and may be a safety concern.

The connection system that connects the electrically conductive member to the external energy source includes a machine contactor 242. In the example of FIG. 2, the machine contactor 242 is located at the work machine 200 side of the electrically conductive member 236. The machine contactor 242 is mechanically moveable between a closed position and an open position. In the closed position, the energy receptacle of the work machine and the electrically conductive member are physically and electrically connected, and electrical energy can be received by the work machine when the machine contactor is closed. In the open position, the electrically conductive member and the energy receptacle of the work machine are physically and electrically disconnected.

FIG. 5 is an illustration of another example of a work machine 200. The work machine includes a machine contactor 542 that is within an enclosure that can be referred to as an energy transfer box (ETB). The machine contactor 542 includes a linkage within the enclosure to physically disconnect the electrically conductive member from the energy receptacle of the work machine. The enclosure contains or extinguishes arcing that can occur when the machine contactor 542 is moved to the open position while the work machine 200 is under load.

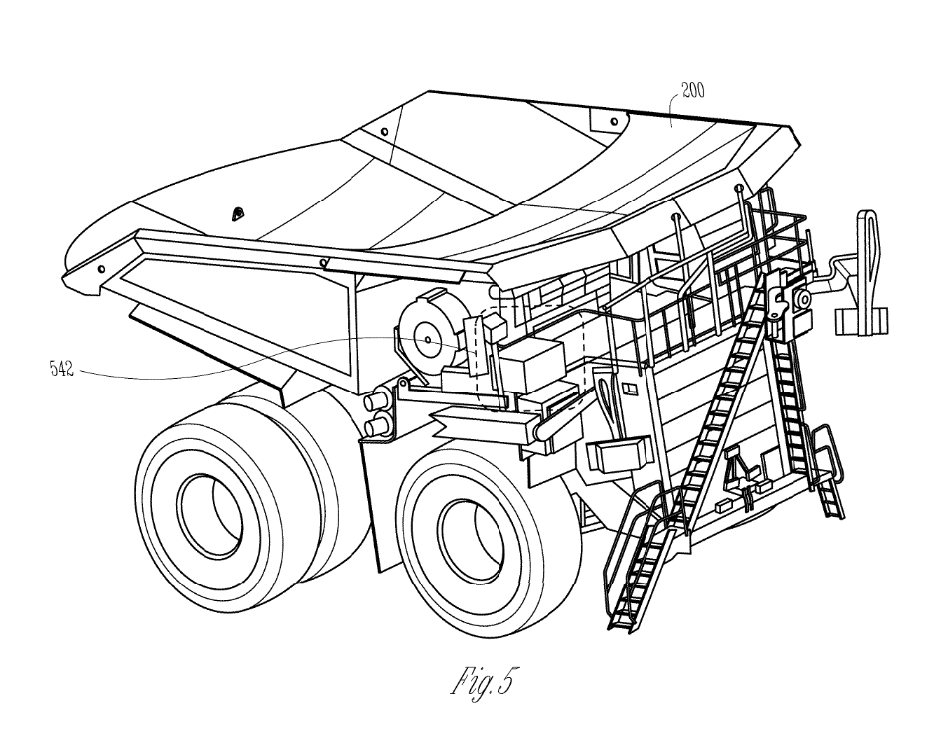

FIG. 6 is an exploded of the enclosure 644 and the machine contactor. The machine contactor extinguishes arcs with long arc chutes when the machine contactor moves to the open position and arcing is confined to the enclosure 644. The machine contactor may include large capacity electrical contacts to connect high and low poles of the electrically conductive member and the energy receptacle of the work machine. The linkage can include one or more of a solenoid, gearing, and hydraulics to facilitate physical disconnecting of the electrical contacts of electrically conductive member and the electrical contacts of the energy receptacle of the work machine.

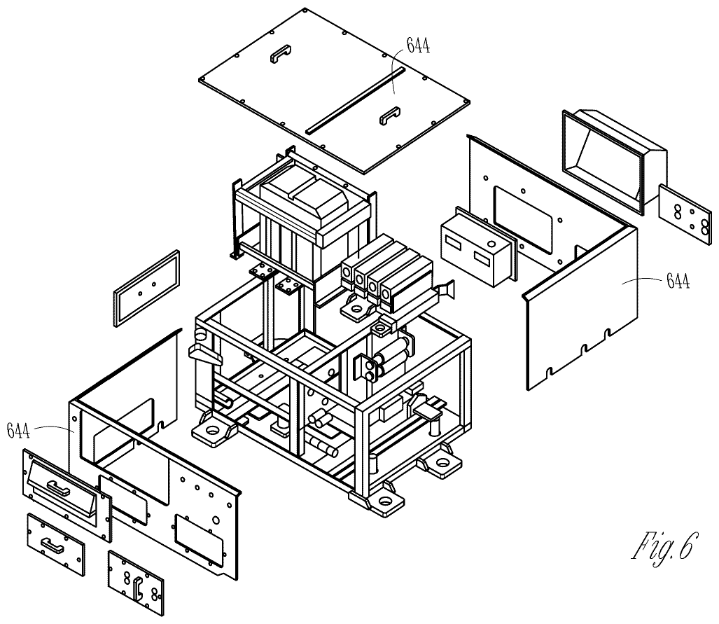

FIG. 7 shows that the connection system of the work machine includes a controller 748 to manage electrical energy delivery to the electrical power system of the work machine. The controller 748 includes logic circuitry to perform the functions described for the controller. The controller 748 can include one or more processors (e.g., microprocessors, digital signal processors (DSP), application specific integrated circuits (ASICs), a programmable gate arrays (PGAs), or equivalent discrete or integrated logic circuitry). The logic circuitry may implement a logic sequencer. A logic sequencer refers to a state machine or other logic circuit that sequentially steps through a fixed series of steps to perform the functions described. A logic sequencer can be implemented using hardware, firmware, or software.

The controller 748 selectively opens the member contactor 240 or the machine contactor 242 in response to an indication to disconnect the work machine 200 from the external energy source. The indication may be a signal generated by an operator using a user interface of the work machine and received by the controller 748. The indication may be a signal generated by a supervisory device separate from the work machine and sent to the work machine.

The controller 748 determines the operating state of the work machine 200. If the controller detects that the work machine is operating under load, the controller initiates moving the machine contactor to the open position to disconnect the work machine from the external energy source. If the work machine is idle or the traction system is off, the controller 748 may initiate moving either the machine contactor or the member contactor to the open position to disconnect the work machine from the external energy source. The controller 748 may initiate moving either of the machine contactor or the member contactor to the closed position in response to an indication to connect the work machine to the external energy source.

### Industrial Applicability

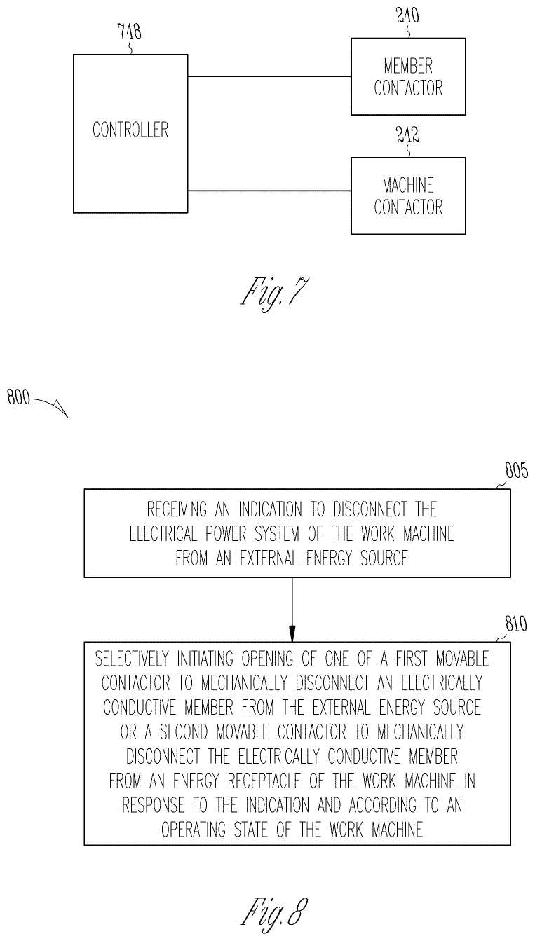

FIG. 8 is a flow diagram of a method 800 of controlling operation of an electrically powered work machine. The work machine is a mobile work machine and may be a mining truck, wheel loader, grader, scraper, dozer, excavator, compactor, or other type of mobile work machine. The mobile work machine is powered by an external energy source not included on the work machine. The electrical energy is provided to the work machine by an electrically conductive member. The electrically conductive member may move with the work machine to maintain power.

At block 805, a controller of the work machine receives an indication to disconnect the power system of the work machine from the external energy source. The indication may be a disconnect signal produced by a user interface of the work machine in response to an input from an operator of the work machine. In certain examples, the indication to disconnect may be automatically generated by a diagnostic device of the work machine.

The work machine includes at least two contactors that connect the external power source to the work machine. The first contactor is a member contactor that connects the electrically conductive member to the external power source. The external power source may include one or more power rails or power cables to deliver the electrical energy at the location of the work machine. The second contactor is a machine contactor located on the work machine and connects the electrically conductive member to the energy receptacle of the work machine.

The contactors are movable. The member contactor is movable to an open position to mechanically disconnect the electrically conductive member from the external energy source and may also be movable to a closed position to connect the electrically conductive member to the external energy source. The machine contactor is movable to mechanically disconnect the energy receptacle of the work machine from the electrically conductive member in an open contactor position and may also be movable to connect the energy receptacle to the electrically conductive member in a closed contactor position.

At block 810, the controller selectively initiates opening one of the contactors to in response to an indication to disconnect the work machine from the external energy source. Which contactor is moved to the open position depends on the state of the work machine. The controller can determine the state of the work machine; including whether the work machine is off, idle, or under load. If the work machine is under load, the electrically conductive member may be conducting a large current that also flows through the contactors. Physically opening a contactor while conducting a large current can cause arcing at the contactors. If the member contactor is opened, arcing at the member contactor can be a safety hazard and can cause damage to components of the electrically conductive member and the external energy source. Opening the machine contactor when the machine contactor is conducting a large current can confine the arcing to the work machine side of the electrically conductive member. The controller opens the machine contactor in response to the indication to disconnect when the work machine is under load. The enclosure containing the machine contactor is designed to extinguish lang arcs resulting from an open circuit. The reduces erosion of brush electrical contacts of the electrically conductive member and external energy source. The controller may open either the machine contactor or the member contactor when the machine is idle, or the traction system is off and the member contactor is not conducting a large current.

The machine contactor may be placed within an enclosure that limits the arcing (especially long arcing chutes) when the machine contactor is opened under load to reduce safety risk and to reduce damage to components of the electrically conductive member and the work machine. The controller may initiate moving the machine contactor to the closed position in response to an indication to connect the work machine to the external energy source.

The techniques described make operation of the work machine safer for bystanders by containing the arcing within the enclosure rather than at the interface to the external energy source where the bystanders may be exposed to the arcing. The techniques also reduce the amount of arcing occurring in open air where environmental conditions could cause the arcing to compromise insulation systems, and the arcing could progress to arcing between high and low poles at the interface to the external energy source or from the external energy source to earth ground. Reducing the amount of arcing occurring in open air also reduces damage and erosion to the electrically conductive member and the external energy source.

The above detailed description is intended to be illustrative, and not restrictive. The scope of the disclosure should, therefore, be determined with references to the appended claims, along with the full scope of equivalents to which such claims are entitled.

What is claimed is:

1. A connection system for connecting a work machine to an external large-capacity energy source external to the work machine, the system comprising:
an electrically conductive member configured to provide electrical energy from the external energy source to an energy receptacle of the work machine;
a first contactor mechanically movable between a closed position electrically connecting the external energy source and the electrically conductive member, and an open position physically disconnecting the external energy source and the electrically conductive member;
a second contactor mechanically movable between a closed position electrically connecting the electrically conductive member and the energy receptacle, and an open position physically disconnecting the electrically conductive member and the energy receptacle; and
a controller configured to receive an indication to disconnect an electrical power system of the work machine from the external energy source; and selectively initiate opening of the first contactor or the second contactor according to the received indication.

2. The system of claim 1, wherein the controller is configured to:
detect that the work machine is under load; and
initiate opening of the second contactor in response to determining that the work machine is under load and receiving the indication to electrically disconnect the electrical power system of the work machine from the external energy source.

3. The system of claim 1, wherein the controller is configured to:
detect that the work machine is idle; and
initiate opening the first contactor in response to determining that the work machine is idle and receiving the indication to disconnect the electrical power system of the work machine from the external energy source.

4. The system of claim 1, wherein the controller is configured to:
detect that a traction system of the work machine is off; and
initiate opening of the first contactor in response to determining that the traction system is off and receiving the indication to disconnect the electrical power system of the work machine from the external energy source.

5. The system of claim 1, wherein the first contactor includes linkage movable to connect the electrically conductive member to an external energy source that includes a power rail, and movable to disconnect the electrically conductive member from the power rail.

6. The system of claim 1,
wherein the electrically conductive member is an electrically conductive tether;
wherein the first contactor includes linkage movable to disconnect the electrically conductive tether from the external energy source; and
wherein the second contactor includes linkage movable to disconnect the electrically conductive tether from the energy receptacle.

7. The system of claim 1,
wherein the electrically conductive member is a pantograph and the external energy source is a power line;
wherein the first contactor includes linkage movable to disconnect the pantograph and the power line; and
wherein the second contactor includes linkage movable to disconnect the pantograph and the energy receptacle.

8. The system of claim 1, wherein the second contactor is disposed within an enclosure configured to contain arcing when the second contactor is moved from the closed position to the open position while the work machine is under load.

9. A method of controlling operation of an electrically powered work machine, the method comprising:
receiving, by a controller of the work machine, an indication to disconnect an electrical power system of the work machine from an external energy source external to the work machine; and
selectively initiating, by the controller, opening of one of a first movable contactor to mechanically disconnect an electrically conductive member from the external energy source or a second movable contactor to mechanically disconnect the electrically conductive member from an energy receptacle of the work machine in response to the indication to disconnect the electrical power system and according to an operating state of the work machine.

10. The method of claim 9, including:
detecting, by the controller, that the work machine is under load; and
initiating opening of the second contactor in response to determining that the work machine is under load and receiving the indication to electrically disconnect the electrical power system of the work machine from the external energy source.

11. The method of claim 10, including containing arcing at the second contactor resulting from the second contactor moving from a closed position to an open position while the work machine is under load.

12. The method of claim 9, including:
detecting, by the controller, that the work machine is idle; and
initiating opening of the first contactor in response to determining that the work machine is idle and receiving the indication to electrically disconnect the electrical power system of the work machine from the external energy source.

13. The method of claim 9, including:
detecting, by the controller, that the work machine is off; and
initiating opening of the first contactor in response to determining that the work machine is off and receiving the indication to electrically disconnect the electrical power system of the work machine from the external energy source.

14. The method of claim 9, including:
initiating, by the controller, moving of linkage of the first contactor to physically disconnect the electrically conductive member from a power rail of the external energy source in response to the indication to disconnect the electrical power system and according to the operating state of the work machine.

15. The method of claim 9, including:
initiating, by the controller, moving of linkage of the first contactor to physically disconnect an electrically conductive tether from the external energy source, or moving of linkage of the second contactor to physically disconnect the electrically conductive tether from the energy receptacle of the work machine, in response to the indication to disconnect the electrical power system and according to an operating state of the work machine.

16. The method of claim 9, including:
initiating, by the controller, moving of linkage of the first contactor to physically disconnect a pantograph from a power line, or moving of linkage of the second contactor to physically disconnect the pantograph from the energy receptacle of the work machine, in response to the indication to disconnect the electrical power system and according to an operating state of the work machine.

17. An apparatus for an electrically powered work machine, the apparatus comprising:
an energy receptacle for the work machine to receive electrical energy from an electrically conductive member;
a machine contactor mechanically movable between a closed position electrically connecting the energy receptacle and the electrically conductive member, and an open position physically disconnecting the electrically conductive member and the energy receptacle; and
a controller configured to:
determine that the work machine is operating under load;
receive an indication to disconnect the work machine from an external energy source; and
initiate moving the machine contactor to the open position in response to the received indication and the determining that the work machine is operating under load.

18. The apparatus of claim 17, including an enclosure configured to contain arcing, and wherein the energy receptacle and the machine contactor are arranged within the enclosure.

19. The apparatus of claim 17 including:
the electrically conductive member; and
a member contactor mechanically movable between a closed position electrically connecting an external energy source and the electrically conductive member, and an open position physically disconnecting the external energy source and the electrically conductive member; and
wherein the controller is configured to initiate moving the member contactor to the open position in response to the received indication to disconnect the work machine from the external energy source and determining that the work machine is not operating under load.

20. The apparatus of claim 17, wherein the controller is configured to initiate moving the machine contactor to the closed position in response to an indication to connect the work machine to the external energy source.
